(19) United States
(12) Patent Application Publication
(10) Pub. No.: US 2025/0362439 A1
(43) Pub. Date: Nov. 27, 2025

(54) POLARIZATION INTERFERENCE ELEMENT AND FILTER

(71) Applicant: FUJIFILM Corporation, Tokyo (JP)

(72) Inventors: Yukito SAITOH, Minamiashigara-shi (JP); Yujiro YANAI, Minamiashigara-shi (JP); Kazuya HISANAGA, Minamiashigara-shi (JP)

(73) Assignee: FUJIFILM Corporation, Tokyo (JP)

(21) Appl. No.: 19/290,622

(22) Filed: Aug. 5, 2025

Related U.S. Application Data
(63) Continuation of application No. PCT/JP2024/009542, filed on Mar. 12, 2024.

(30) Foreign Application Priority Data
Mar. 13, 2023 (JP) 2023-038827
Jan. 26, 2024 (JP) 2024-010224

(51) Int. Cl. G02B 5/28; G02B 5/30

(52) U.S. Cl. CPC G02B 5/28; G02B 5/3025

(57) ABSTRACT

Provided is a novel polarization interference element that can be used for a band-pass filter and the like. The polarization interference element has two or more birefringent layer sets in a thickness direction, each set consisting of two birefringent layers, in which the birefringent layer includes an in-plane periodic structure layer having a periodic structure in which two types of unit layers having different refractive indices are alternately laminated adjacent to each other in an in-plane direction, slow axes of the birefringent layers constituting the birefringent layer set intersect with each other, and in-plane retardations of the two birefringent layers constituting the birefringent layer set are equal to each other.

### CROSS-REFERENCE TO RELATED APPLICATIONS

This application is a Continuation of PCT International Application No. PCT/JP2024/009542, filed on Mar. 12, 2024, which claims priority under 35 U.S.C. § 119(a) to Japanese Patent Application No. 2023-038827, filed on Mar. 13, 2023, and Japanese Patent Application No. 2024-010224, filed on Jan. 26, 2024. The above applications are hereby expressly incorporated by reference, in their entirety, into the present application.

### BACKGROUND OF THE INVENTION

### 1. Field of the Invention

The present invention relates to a polarization interference element and a filter using the same.

### 2. Description of the Related Art

A band-pass filter that transmits light in a specific wavelength range and shields light in other wavelength ranges is used in various optical devices.

As the band-pass filter, a polarization interference filter using a dielectric multi-layer film, a filter having a polarizer and a birefringent crystal in combination, and the like are known.

In addition, a band-pass filter is also known, in which a birefringent plate (λ/2 plate) in which an angle formed between a direction of a transmission axis of a polarizer and a slow axis is +ρ, and a birefringent plate in which the angle is −ρ, the both plates having the same thickness, are alternately laminated between polarizers arranged in a crossed nicols state, as described in JP2004-101577A.

JP2004-101577A proposes, as an optical filter (band-pass filter) having a small number of components, an optical filter consisting of crystals and having a structure where two types of polarization regions having different crystals are periodically arranged, in which the two different types of polarization regions are different in the principal axis of a refractive index ellipsoid cut parallel to an interface between the two different types of polarization regions.

### SUMMARY OF THE INVENTION

As described above, band-pass filters having various configurations are known.

An object of the present invention is to provide a novel polarization interference element that is different from any of those elements and that can be used for a band-pass filter and the like.

In order to accomplish the object, the present invention has the following configurations.

[1] A polarization interference element including:
two or more birefringent layer sets in a thickness direction, each set consisting of two birefringent layers,
in which the birefringent layer includes an in-plane periodic structure layer having a periodic structure in which two types of unit layers having different refractive indices are alternately laminated adjacent to each other in an in-plane direction,
slow axes of the birefringent layers constituting the birefringent layer set intersect with each other, and
in-plane retardations of the two birefringent layers constituting the birefringent layer set are equal to each other.

[2] The polarization interference element according to [1],
in which the birefringent layer further includes a thickness-direction periodic structure layer consisting of a periodic structure in which two types of unit layers having different refractive indices are alternately laminated adjacent to each other in the thickness direction.

[3] The polarization interference element according to [2],
in which in the one birefringent layer, a sum of in-plane retardations of the in-plane periodic structure layer is 1.33 times to 4 times a sum of thickness-direction retardations of the thickness-direction periodic structure layer.

[4] The polarization interference element according to any one of [1] to [3],
in which the polarization interference element has three or more birefringent layer sets in the thickness direction, and
an angle formed between in-plane slow axes of the two birefringent layers and in-plane retardations in the birefringent layers differ between birefringent layer sets arranged on both sides in the thickness direction and birefringent layer set arranged in a central part in the thickness direction.

[5] A filter including:
the polarization interference element according to any one of [1] to [4]; and
two polarizers that sandwich the polarization interference element in a thickness direction,
in which the two polarizers are arranged such that transmission axes of the two polarizers are orthogonal to each other.

[6] The filter according to [5],
in which a retardation layer is included between one or both of the two polarizers and the birefringent layer set, and
an in-plane slow axis of the retardation layer is parallel to an absorption axis of either of the two polarizers.

According to the present invention, it is possible to provide a novel polarization interference element that can be used for a band-pass filter and the like.

### BRIEF DESCRIPTION OF THE DRAWINGS

FIG. 1 is a view conceptually showing an example of a filter having a polarization interference element of an embodiment of the present invention.

FIG. 2 is a view conceptually showing an example of a birefringent layer set included in the polarization interference element of the embodiment of the present invention.

FIG. 3 is a view conceptually showing another example of the birefringent layer set included in the polarization interference element of the embodiment of the present invention.

FIG. 4 is a graph for describing a filter including the polarization interference element of the embodiment of the present invention.

FIG. 5 is a graph for describing a filter including the polarization interference element of the embodiment of the present invention.

### DESCRIPTION OF THE PREFERRED EMBODIMENTS

Hereinafter, a polarization interference element and a filter of embodiments of the present invention will be described in detail based on suitable Examples shown in the accompanying drawings.

In the present specification, numerical ranges represented by “to” include numerical values before and after “to” as lower limit values and upper limit values.

In the present specification, for example, angles such as “45°”, “parallel”, “perpendicular” or “orthogonal” mean that a difference from an exact angle is within a range of less than 5 degrees unless otherwise noted. The difference from the exact angle is preferably less than 3 degrees, and more preferably less than 1 degree.

In the present specification, the meaning of the term “the same”, “equal”, or the like includes a case where an error range is generally allowable in the technical field.

In the present specification, Re(λ) represents an in-plane retardation at a wavelength of λ.

In the present specification, Re(λ) is a value measured at the wavelength of λ using AxoScan (manufactured by Axometrics, Inc.). By inputting an average refractive index ((nx+ny+nz)/3) and a film thickness (d (μm)) to AxoScan, the following expression can be calculated.

### Slow Axis Direction (°)

$$R e ( λ ) = R 0 ( λ )$$

Furthermore, R0(λ) is displayed as a numerical value calculated by AxoScan, but means Re(λ).

In addition, all of the drawings shown below are conceptual views for describing the present invention, and the positional relationship, size, thickness, shape, and the like of each constituent element are different from the actual ones.

### Polarization Interference Element and Filter

The polarization interference element of an embodiment of the present invention is a polarization interference element including:
two or more birefringent layer sets in a thickness direction, each set consisting of two birefringent layers, in which the birefringent layer includes an in-plane periodic structure layer having a periodic structure in which two types of unit layers having different refractive indices are alternately laminated adjacent to each other in an in-plane direction, slow axes of the birefringent layers constituting the birefringent layer set intersect with each other, and in-plane retardations of the two birefringent layers constituting the birefringent layer set are equal to each other.

In addition, the filter of the embodiment of the present invention is a filter including:
the polarization interference element; and
two polarizers that sandwich the polarization interference element in a thickness direction,
in which the two polarizers are arranged such that transmission axes of the two polarizers are orthogonal to each other.

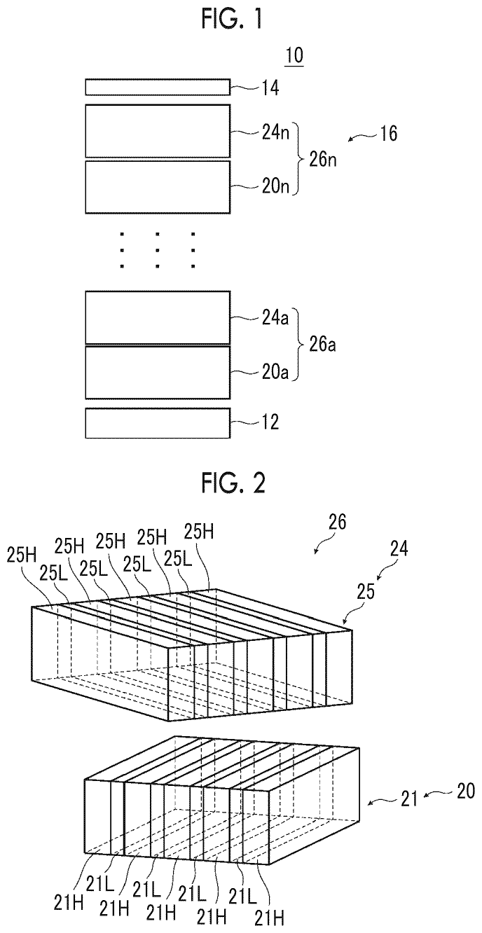

An example of the filter of the embodiment of the present invention, the filter having the polarization interference element of the embodiment of the present invention, is conceptually shown in FIG. 1.

A filter 10 shown in FIG. 1 is a band-pass filter (narrowband filter) that transmits light in a specific wavelength range and shields light in the other wavelength range. The filter 10 includes a first polarizer 12, a second polarizer 14, and a polarization interference element 16. The polarization interference element 16 is arranged between the first polarizer 12 and the second polarizer 14.

The first polarizer 12 and the second polarizer 14 are polarizers (polarizing plates) that transmit linearly polarized light in a predetermined direction, and are arranged in a crossed nicols state with transmission axes being orthogonal to each other.

The first polarizer 12 and the second polarizer 14 are not limited, and various known linear polarizers such as an iodine-based polarizer, a dye-based polarizer using a dichroic dye, a polyene-based polarizer, and a wire grid polarizer can be used.

In the filter 10 in the example shown in the drawing, the polarization interference element 16 is arranged between the first polarizer 12 and the second polarizer 14.

Furthermore, the first polarizer 12 and the second polarizer 14 are spaced from the polarization interference element 16 in FIG. 1.

However, the present invention is not limited thereto, and the first polarizer 12, the second polarizer 14, and the polarization interference element 16 may be laminated in contact with each other. In addition, in a case where the first polarizer 12 and the second polarizer 14 are in contact with the polarization interference element 16, they may be adhered to each other with an adhesive which is transparent to transmitted light, such as an optical clear adhesive (OCA) and an acrylic pressure sensitive adhesive, as necessary.

The polarization interference element 16 is an optical element that acts as a λ/2 retardation plate for light in a specific wavelength range (specific wavelength) and does not act as a retardation layer for light in other wavelength ranges.

As described above, the first polarizer 12 and the second polarizer 14 are polarizers that are arranged in a crossed nicols state with transmission axes being orthogonal to each other.

Accordingly, with regard to the light incident onto the filter 10, only linearly polarized light in a predetermined direction is transmitted through the first polarizer 12. In the linearly polarized light, the polarization direction of light having a specific wavelength is rotated by 90° by the polarization interference element 16, and the light having a specific wavelength is incident on and transmitted through the second polarizer 14 arranged in a crossed nicols state with respect to the first polarizer 12. In contrast, the polarization interference element 16 does not act as a retardation layer for light in a wavelength range other than the specific wavelength range. Accordingly, the light is incident onto the second polarizer 14 arranged in a crossed nicols state with respect to the first polarizer 12 and is shielded.

With such an optical action, the filter 10 functions as a band-pass filter that transmits only light in a specific wavelength range and shields other light.

The polarization interference element 16 is formed by laminating an even number of birefringent layers.

Specifically, the polarization interference element 16 is formed by laminating two or more birefringent layer sets 26, each consisting of the first birefringent layer 20 and the second birefringent layer 24 in the thickness direction.

Accordingly, the total number of laminations layers of the first birefringent layers 20 and the second birefringent layers 24 is an even number.

In the example shown in FIG. 1, the polarization interference element 16 has a birefringent layer set from the first to the n-th birefringent layer.

In one birefringent layer set 26, the first birefringent layer 20 and the second birefringent layer 24 each include an in-plane periodic structure layer consisting of a periodic structure in which two types of unit layers (a layer with a high refractive index and a layer with a low refractive index) having different refractive indices are alternately laminated adjacent to each other in the in-plane direction.

In the following description, the birefringent layer set closest to the first polarizer 12 side will be defined as a first birefringent layer set 26a, the birefringent layer set closest to the second polarizer 14 side will be defined as an n-th birefringent layer set 26n, and in a case where it is not necessary to distinguish the birefringent layer sets from each other, the birefringent layer sets will also be referred to as the birefringent layer set 26. Moreover, the first birefringent layer included in the first birefringent layer set 26a will be represented by a reference numeral 20a, the second birefringent layer will be represented by a reference numeral 24a, the first birefringent layer included in the n-th birefringent layer set 26n will be represented by a reference numeral 20n, and the second birefringent layer will be represented by a reference numeral 24n. In a case where it is not necessary to distinguish the first birefringent layers from each other, the first birefringent layers will also be referred to as the first birefringent layer 20, and in a case where it is not necessary to distinguish the second birefringent layers from each other, the second birefringent layers will also be referred to as the second birefringent layer 24. In addition, in a case where it is not necessary to distinguish between the first birefringent layer 20 and the second birefringent layer 24, the first birefringent layer 20 and the second birefringent layer 24 are also simply referred to as a birefringent layer.

A view conceptually showing an example of one birefringent layer set 26 is shown in FIG. 2. Furthermore, in the example shown in FIG. 2, the birefringent layers are shown to be spaced apart from each other for the sake of description.

As shown in FIG. 2, the birefringent layer set 26 has the first birefringent layer 20 and the second birefringent layer 24.

The first birefringent layer 20 includes the in-plane periodic structure layer 21. The in-plane periodic structure layer 21 is a layer consisting of a periodic structure in which two types of unit layers having different refractive indices are alternately laminated adjacent to each other in an in-plane direction. Among the unit layers, the layer having a higher refractive index is referred to as a layer 21H with a high refractive index and a layer having a lower refractive index in the unit layer is referred to as a layer 21L with a low refractive index, and as shown in FIG. 2, the in-plane periodic structure layer 21 has a periodic structure in which the layer 21H with a high refractive index and the layer 21L with a low refractive index are alternately laminated along one direction in the in-plane direction.

Similarly, the second birefringent layer 24 includes the in-plane periodic structure layer 25. The in-plane periodic structure layer 25 is a layer consisting of a periodic structure in which two types of unit layers having different refractive indices are alternately laminated adjacent to each other in an in-plane direction. Among the unit layers, the layer having a higher refractive index is referred to as a layer 25H with a high refractive index and a layer having a lower refractive index in the unit layer is referred to as a layer 25L with a low refractive index, and as shown in FIG. 2, the in-plane periodic structure layer 25 has a periodic structure in which the layer 25H with a high refractive index and the layer 25L with a low refractive index are alternately laminated along one direction in the in-plane direction.

Furthermore, the in-plane direction is a direction parallel to the main surface of the sheet-like material (each layer). In addition, the main surface is the maximum surface of a sheet-like material (each layer).

The birefringent layer including the in-plane periodic structure layer having a periodic structure in which the layer with a high refractive index and the layer with a low refractive index are alternately laminated in this manner acts as a birefringent layer in which the extension direction of the layer with a high refractive index (the layer with a low refractive index) in the in-plane direction is taken as a slow axis and the lamination direction (hereinafter also referred to as the periodic direction) of the layer with a high refractive index and the layer with a low refractive index is taken as a fast axis. The in-plane periodic structure layer has the same function as a so-called negative A-plate.

In the present invention, the first birefringent layer 20 and the second birefringent layer 24 constituting one birefringent layer set 26 are laminated such that the in-plane slow axes of the layers intersect with each other. That is, as shown in FIG. 2, the lamination direction (periodic direction) of the layer 21H with a high refractive index and the layer 21L with a low refractive index in the in-plane periodic structure layer 21 of the first birefringent layer 20, and the lamination direction (periodic direction) of the layer 25H with a high refractive index and the layer 25L with a low refractive index in the in-plane periodic structure layer 25 of the second birefringent layer 24 intersect with each other.

Furthermore, in the example shown in FIG. 2, in order to describe the configuration of the birefringent layer, the first birefringent layer 20 and the second birefringent layer 24 are each laminated in different rectangular shapes in different directions, and thus have some non-overlapping regions. However, the first birefringent layer 20 and the second birefringent layer 24 may be laminated to completely overlap each other as long as the in-plane slow axes thereof intersect with each other.

In addition, in one birefringent layer set 26, the in-plane retardation of the first birefringent layer 20 and the in-plane retardation of the second birefringent layer 24 are substantially equal to each other.

In such a birefringent layer set 26, a bisector of an angle formed between the slow axis direction of the first birefringent layer 20 and the slow axis direction of the second birefringent layer 24 is arranged to be parallel to one of the transmission axis or the absorption axis of the polarizer (the first polarizer 12 or the second polarizer 14) arranged in a crossed nicols state. That is, in a case where one of the transmission axis or the absorption axis of the polarizer (the first polarizer 12 and the second polarizer 14) is defined as a reference line, for example, in a case where a clockwise angle is denoted by a plus and a counterclockwise angle is denoted by a minus in a view from the first polarizer 12 side, the angle of the slow axis of the first birefringent layer 20 and the angle of the slow axis of the second birefringent layer 24 have equal absolute values but have different signs of plus and minus.

The polarization interference element 16 of the embodiment of the present invention has two or more birefringent layer sets 26. In this case, the plurality of birefringent layer sets 26 are arranged such that bisectors of angles between the slow axis direction of the first birefringent layer 20 and the slow axis direction of the second birefringent layer 24 are parallel to each other.

In the example shown in FIG. 1, all of the first birefringent layers 20 have the same configuration, and all of the second birefringent layers 24 also have the same configuration. That is, in the polarization interference element 16 shown in FIG. 1, all of the first birefringent layers 20 have equal in-plane retardations (Δnd's), equal angles of the in-plane slow axes, and the like, and all of the second birefringent layers 24 have equal in-plane retardations (Δnd's) and equal angles of the in-plane slow axes.

The light that passes through the crystal polarization interference element 16 is repeatedly and alternately influenced by the slow axis at a certain angle possessed by the first birefringent layer 20 and the slow axis at an angle possessed by the second birefringent layer 24, both the slow axes having the same absolute value and different reference numerals.

Therefore, it is possible to form the polarization interference element 16 that acts as a λ/2 retardation plate for light in a specific wavelength range and does not act as a retardation plate for light in other wavelength ranges, that is, does not feel the retardation by setting Δnd's of the first birefringent layer 20 and the second birefringent layer 24 depending on the wavelength range transmitted through the filter 10, and adjusting the angles of the slow axes in the first birefringent layer 20 and the second birefringent layer 24 according to the total number of laminations of the first birefringent layers 20 and the second birefringent layers 24 in the polarization interference element 16.

As described above, the filter 10, in which the polarization interference element 16 acting as a λ/2 retardation plate only for light in a specific wavelength range is arranged between the first polarizer 12 and the second polarizer 14 arranged in a crossed nicols state, rotates the polarization direction of light having a specific wavelength among the linearly polarized light transmitted through the first polarizer 12 by 90° with the polarization interference element 16, and transmits the light through the second polarizer 14 arranged in a crossed nicols state with the first polarizer 12. On the other hand, since the polarization interference element 16 does not act as a retardation layer for light in a wavelength range other than the specific wavelength range, the linearly polarized light transmitted through the first polarizer 12 is transmitted through the polarization interference element 16 and shielded by the second polarizer 14. With such an optical action, the filter 10 functions as a band-pass filter that transmits only light in a specific wavelength range and shields other light. As described above, the polarization interference element of the embodiment of the present invention can be used for a band-pass filter having a novel configuration different from that in the related art.

As described above, the polarization interference element 16 acts as a λ/2 retardation plate only for light in a specific wavelength range. Accordingly, the in-plane retardations (Δnd's) of the first birefringent layer 20 and the second birefringent layer 24 are half the central wavelength (half-wavelength) of a wavelength range assumed to be transmitted through the filter 10, that is, a wavelength at which the polarization interference element 16 is assumed to act as a λ/2 retardation plate.

For example, in a case where the wavelength at which the polarization interference element 16 acts as a λ/2 retardation plate, that is, the central wavelength of a wavelength range transmitted through the filter 10 is assumed to be 550 nm, the Δnd's of the first birefringent layer 20 and the second birefringent layer 24 may be set to 275 nm. In a case where the first birefringent layer 20 consists of the in-plane periodic structure layer 21, the in-plane retardation of the first birefringent layer 20 is mainly caused by the in-plane periodic structure layer 21, and thus the Δnd of the in-plane periodic structure layer 21 may be set to 275 nm. Similarly, in a case where the second birefringent layer 24 consists of the in-plane periodic structure layer 25, the in-plane retardation of the second birefringent layer 24 is mainly caused by the in-plane periodic structure layer 25, and thus the Δnd of the in-plane periodic structure layer 25 may be set to 275 nm.

Furthermore, the Δnd's of the first birefringent layer 20 and the second birefringent layer 24 may have an error of about ±10% with respect to half the central wavelength of the wavelength range transmitted through the filter 10.

The Δnd of the first birefringent layer 20 and the second birefringent layer 24 is determined depending on the thickness of the in-plane periodic structure layers (21 and 25), the refractive index of the layer with a high refractive index, the refractive index of the layer with a low refractive index, the width of the layer with a high refractive index, the width of the layer with a low refractive index in the periodic direction, and the like. Accordingly, the thickness of the in-plane periodic structure layers (21, 25), the refractive index of the layer with a high refractive index, the refractive index of the layer with a low refractive index, the width of the layer with a high refractive index, the width of the layer with a low refractive index in the periodic direction may be appropriately set such that the Δnd of the first birefringent layer 20 and the second birefringent layer 24 is a desired Δnd, depending on the wavelength assumed to be transmitted through the filter 10.

The in-plane periodic structure layer will be described in detail later.

Here, in the present invention, it is preferable that the birefringent layer further includes a thickness-direction periodic structure layer consisting of a periodic structure in which two types of unit layers having different refractive indices are alternately laminated adjacent to each other in the thickness direction.

Furthermore, the thickness direction is a direction perpendicular to the main surface of the sheet-like material (each layer).

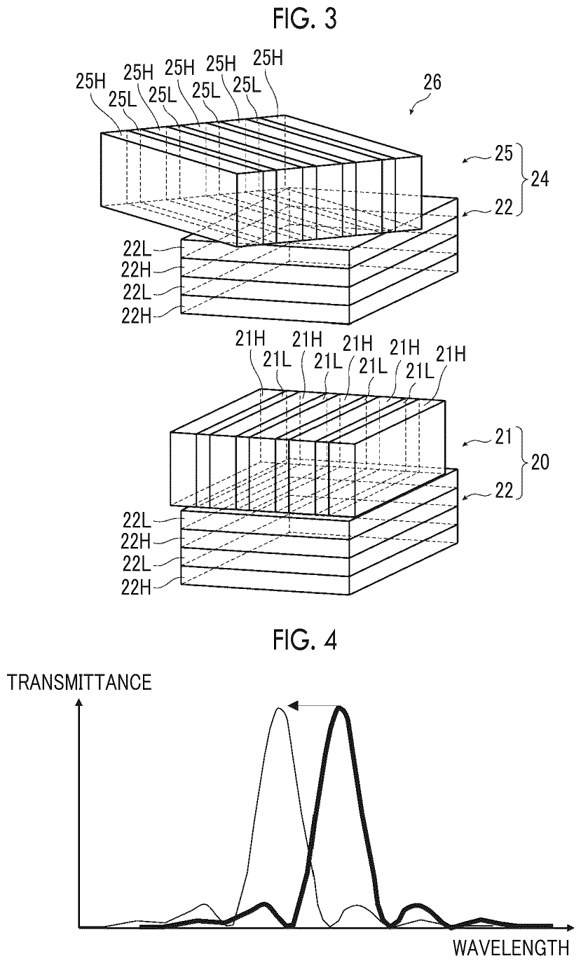

A view conceptually showing another example of the birefringent layer set included in the polarization interference element of the embodiment of the present invention is shown in FIG. 3.

A birefringent layer set 26 shown in FIG. 3 has a first birefringent layer 20 and a second birefringent layer 24.

The first birefringent layer 20 includes the in-plane periodic structure layer 21 and the thickness-direction periodic structure layer 22. The in-plane periodic structure layer 21 has the same configuration as the in-plane periodic structure layer 21 in the example shown in FIG. 2, and thus a description thereof will not be repeated. The thickness-direction periodic structure layer 22 is a layer consisting of a periodic structure in which two types of unit layers having different refractive indices are alternately laminated adjacent to each other in the thickness direction. Among the unit layers, the layer having a higher refractive index is referred to as a layer 22H with a high refractive index and a layer having a lower refractive index in the unit layer is referred to as a layer 22L with a low refractive index, and as shown in FIG. 3, the thickness-direction periodic structure layer 22 has a periodic structure in which the layer 22H with a high refractive index and the layer 22L with a low refractive index are alternately laminated along the thickness direction.

Similarly, the second birefringent layer 24 includes the in-plane periodic structure layer 25 and the thickness-direction periodic structure layer 22. The in-plane periodic structure layer 25 has the same configuration as the in-plane periodic structure layer 25 in the example shown in FIG. 2, and thus a description thereof will not be repeated. The thickness-direction periodic structure layer 22 is a layer consisting of a periodic structure in which two types of unit layers having different refractive indices are alternately laminated adjacent to each other in the thickness direction, similar to the thickness-direction periodic structure layer 22 included in the first birefringent layer 20, and the thickness-direction periodic structure layer 22 has a periodic structure in which the layer 22H with a high refractive index and the layer 22L with a low refractive index are alternately laminated in the thickness direction.

The thickness-direction periodic structure layer having a periodic structure in which the layer with a high refractive index and the layer with a low refractive index are alternately laminated in the thickness direction is a layer in which the refractive index is the same in any in-plane direction and the refractive index in the thickness direction is different from the refractive index in the in-plane direction. That is, the thickness-direction periodic structure layer has the same function as a so-called negative C-plate.

The direction of the in-plane slow axis in the birefringent layer configured such that the in-plane periodic structure layer and the thickness-direction periodic structure layer are laminated is mainly due to the in-plane periodic structure layer. Therefore, as shown in FIG. 3, the first birefringent layer 20 and the second birefringent layer 24 are laminated such that the lamination direction (periodic direction) of the layer 21H with a high refractive index and the layer 21L with a low refractive index in the in-plane periodic structure layer 21 and the lamination direction (periodic direction) of the layer 25H with a high refractive index and the layer 25L with a low refractive index in the in-plane periodic structure layer 25 of the second birefringent layer 24 intersect with each other.

In addition, in one birefringent layer set 26, the in-plane retardation of the first birefringent layer 20 and the in-plane retardation of the second birefringent layer 24 are substantially equal to each other.

The polarization interference element 16 of the embodiment of the present invention may have two or more birefringent layer sets 26 as shown in FIG. 3. In this case, the plurality of birefringent layer sets 26 are arranged such that bisectors of angles between the slow axis direction of the first birefringent layer 20 and the slow axis direction of the second birefringent layer 24 are parallel to each other. In addition, the arrangement is made such that the bisector is parallel to one transmission axis or absorption axis of one of the polarizers (the first polarizer 12 and the second polarizer 14).

Even in the polarization interference element 16 having the birefringent layer set 26 as shown in FIG. 3, it is possible to form the polarization interference element 16 that acts as a λ/2 retardation plate for light in a specific wavelength range and does not act as a retardation plate for the other light, that is, does not sense a retardation. The filter 10 in which the polarization interference element 16 is arranged between the first polarizer 12 and the second polarizer 14 arranged in a crossed nicols state is a band-pass filter that transmits only light in a specific wavelength range and shields the other light, as in the above-described example.

Here, in the band-pass filter having such a configuration, there occurs a problem in that upon incidence of light from an oblique direction, a wavelength shift occurs, in which a transmission wavelength range moves toward the shorter wavelength side, as shown by the shift from the thick solid line to the thin solid line in FIG. 4, as compared with a case where light is incident from the front.

In contrast, in a case of the configuration in which the birefringent layer has a thickness-direction periodic structure layer as in the example shown in FIG. 3, each of the first birefringent layer 20 and the second birefringent layer 24 can reduce a difference between the retardation that acts on light upon incidence of light from the vertical direction and the retardation that acts on light upon incidence of light from an oblique direction, and it is thus possible to suppress the occurrence of a wavelength shift even upon incidence of light from an oblique direction into the filter.

From the viewpoint of suppressing the short-wavelength shift, in the polarization interference element 16 of the embodiment of the present invention, the absolute value of a sum of the in-plane retardations of the in-plane periodic structure layers 21 of the first birefringent layer 20 is preferably 1.33 times to 4 times, and more preferably about 2 times the absolute value of a sum of the thickness-direction retardations of the thickness-direction periodic structure layers 22. In addition, the absolute value of a sum of the in-plane retardations of the in-plane periodic structure layers 25 of the second birefringent layer 24 is preferably 1.33 times to 4 times, and more preferably about 2 times the absolute value of a sum of the thickness-direction retardations of the thickness-direction periodic structure layers 22.

Furthermore, the in-plane retardation of the in-plane periodic structure layer can be measured using Axo Scan (OPMF-1, manufactured by Axometrics, Inc.). In addition, the thickness-direction retardation of the thickness-direction periodic structure layer can be measured using Axo Scan (OPMF-1, manufactured by Axometrics, Inc.). The in-plane retardation and the thickness-direction retardation can be separated and measured by optical analysis even in a state where the in-plane periodic structure layer and the thickness-direction periodic structure layer are laminated.

The in-plane periodic structure layer and the thickness-direction periodic structure layer of the birefringent layer can be detected using SEM. In addition, the refractive index and the thickness of the layer with a high refractive index and the layer with a low refractive index can be detected by a general optical measurement method such as an ellipsometry method.

For the angles of the slow axes in the first birefringent layer 20 and the second birefringent layer 24 constituting the polarization interference element 16 (the angles with respect to the transmission axes or the absorption axes of the polarizers as a reference), an optimum angle at which the polarization interference element 16 acts as a λ/2 retardation plate may be set by simulation depending on the central wavelength of the wavelength range assumed to be transmitted through the filter 10 and a total number N of laminations of the first birefringent layers 20 and the second birefringent layers 24.

In the simulation, a general optical simulation unit can be used, or calculation can be performed using LCD Master 1D (manufactured by SHINTECH Co., Ltd., Ver 9.8.0.0).

The thickness d of each of the first birefringent layer 20 and the second birefringent layer 24 is not limited, and may be appropriately set to be a thickness that allows the in-plane retardation (Δnd) of each of the first birefringent layer 20 and the second birefringent layer 24 to be a half-wavelength of the central wavelength of the wavelength range transmitted through the filter 10.

The thickness d of each of the first birefringent layer 20 and the second birefringent layer 24 is preferably 0.1 to 5 μm, and more preferably 0.1 to 3 μm.

In addition, the thickness of each of the in-plane periodic structure layer 21 and the thickness-direction periodic structure layer 22 in the first birefringent layer 20, and the thicknesses of each of the in-plane periodic structure layer 25 and the thickness-direction periodic structure layer 22 in the second birefringent layer 24 are not limited, and the thicknesses may be appropriately set such that the absolute value of a sum of the in-plane retardations of the in-plane periodic structure layers (21, 25) is 1.33 times to 4 times the absolute value of a sum of the thickness-direction retardations of the thickness-direction periodic structure layer (22), depending on the refractive index and the like of a material used.

In addition, in the example shown in FIG. 3, one first birefringent layer 20 is configured to have one in-plane periodic structure layer 21 and one thickness-direction periodic structure layer 22, but the present invention is not limited thereto. The first birefringent layer 20 may be configured to have a plurality of in-plane periodic structure layers 21 and/or a plurality of thickness-direction periodic structure layers 22. In a case of the configuration in which the first birefringent layer 20 has a plurality of in-plane periodic structure layers 21 and/or a plurality of thickness-direction periodic structure layers 22, a sum of the in-plane retardations of the plurality of in-plane periodic structure layers 21 may be 1.33 times to 4 times a sum of the thickness-direction retardations of the plurality of thickness-direction periodic structure layers 22.

Similarly, in the example shown in FIG. 3, one second birefringent layer 24 is configured to have one in-plane periodic structure layer 25 and one thickness-direction periodic structure layer 22, but the present invention is not limited thereto. The second birefringent layer 24 may be configured to have a plurality of the in-plane periodic structure layers 25 and/or the thickness-direction periodic structure layers 22. In a case the configuration in which the first birefringent layer 20 has a plurality of the in-plane periodic structure layers 25 and/or the thickness-direction periodic structure layers 22 are provided, a sum of the in-plane retardations of the plurality of in-plane periodic structure layers 25 may be 1.33 times to 4 times a sum of the thickness-direction retardations of the plurality of thickness-direction periodic structure layers 22. In this case, in one first birefringent layer and/or one second birefringent layer, by further dividing the in-plane periodic structure layer and the thickness-direction periodic structure layer to increase the number of the in-plane periodic structure layers and the number of the thickness-direction periodic structure layers, and thus, a difference between a retardation viewed from the front (normal direction) and a retardation viewed from a more oblique direction (direction of a large polar angle) can be reduced, which is thus desirable.

The total number of laminations of the first birefringent layers 20 and the second birefringent layers 24 is not limited as long as the number of the birefringent layer sets 26 is 2 or more, that is, 4 or more and an even number.

The total number of laminations of the first birefringent layers 20 and the second birefringent layers 24 is preferably 6 to 30, more preferably 6 to 20, and still more preferably 6 to 10. That is, the number of the birefringent layer sets 26 is preferably 3 to 15, more preferably 3 to 10, and still more preferably 3 to 5.

Furthermore, in the present invention, as the total number of laminations of the first birefringent layers 20 and the second birefringent layers 24 is increased, that is, as the number of the birefringent layer sets 26 is increased, the wavelength range in which the polarization interference element 16 acts as a λ/2 retardation layer is narrower.

Accordingly, in the present invention, as the total number of laminations of the first birefringent layers 20 and the second birefringent layers 24 is increased, the half-width of the wavelength range of transmitted light is narrower. In other words, the filter 10 can be made as a band-pass filter having a narrower transmission wavelength range as the total number of laminations of the first birefringent layers 20 and the second birefringent layers 24 is increased.

Accordingly, as the total number of laminations of the first birefringent layers 20 and the second birefringent layers 24, that is, the number of the birefringent layer sets 26, a smaller number of layers may be selected for a case where a broad bandwidth is required, and a larger number of layers may be appropriately selected for a case where a narrow bandwidth is required, depending on a required width of the transmission wavelength range of the filter 10.

In the polarization interference element 16 shown in FIG. 1, all of the birefringent layers have the same configuration. That is, in the polarization interference element 16 shown in FIG. 1, all of the first birefringent layers 20 have the same configuration, and all of the second birefringent layers 24 also have the same configuration. That is, in the polarization interference element 16 shown in FIG. 1, all of the first birefringent layers 20 have equal in-plane retardations (Δnd's), and equal angles of the in-plane slow axes and all of the second birefringent layers 24 have equal in-plane retardations (Δnd's) and equal angles of the in-plane slow axes.

However, the present invention is not limited thereto, and the liquid crystal layers may have a distribution of the in-plane retardations (Δnd's) and a distribution of the angles of the in-plane slow axes in the thickness direction. That is, in the present invention, in a case where the first birefringent layer and the second birefringent layer have equal in-plane retardations (Δnd's) and equal values of the angles of the in-plane slow axes for the respective the birefringent layer sets, the in-plane retardations (Δnd's) and/or the angles of the in-plane slow axes of the first birefringent layer and the second birefringent layer may differ from each other for the respective birefringent layer sets.

As an example, a configuration is exemplified, in which three or more birefringent layer sets are provided in the thickness direction, and the in-plane retardations (Δnd's) and the angle between the in-plane slow axes of the first birefringent layer and the second birefringent layer, that is, the angle formed between the in-plane slow axis of the first birefringent layer and the in-plane slow axis of the second birefringent layer differ between the birefringent layer set in the center in the thickness direction (lamination direction) and the birefringent layer sets on both sides in the thickness direction.

Specifically, the in-plane retardations (Δnd's) of the birefringent layers (the first birefringent layers and the second birefringent layers) of the birefringent layer sets on both sides in the thickness direction may be increased and the absolute values of the angles of the in-plane slow axes may be decreased, as compared with the birefringent layers (the first birefringent layers and the second birefringent layers) of the birefringent layer sets in the center in the thickness direction.

As will be described in Examples later, as an example, in a case where the polarization interference element has eight birefringent layers, that is, four birefringent layer sets, in the first birefringent layer set, the in-plane retardation and the angle of the in-plane slow axis of the first birefringent layer (first layer) are denoted by Δnd1 and θ1, respectively, and the in-plane retardation and the angle of the in-plane slow axis of the second birefringent layer (second layer) are denoted by Δnd1 and −θ1, respectively, in the second birefringent layer set, the in-plane retardation and the angle of the in-plane slow axis of the first birefringent layer (third layer) are denoted by Δnd2 that is smaller than Δnd1, and θ2 that is larger than θ1, respectively, and the in-plane retardation and the angle of the in-plane slow axis of the second birefringent layer (fourth layer) are denoted by Δnd2 and −θ2, respectively, in the third liquid crystal layer set, the in-plane retardation and the angle of the in-plane slow axis of the first liquid crystal layer (fifth layer) are denoted by Δnd2 and θ2, respectively, and the in-plane retardation and the angle of the in-plane slow axis of the second birefringent layer (sixth layer) are denoted by Δnd2 and −θ2, respectively, and in the fourth birefringent layer set, the in-plane retardation and the angle of the in-plane slow axis of the first birefringent layer (seventh layer) are denoted by Δnd1 and θ1, respectively, and the in-plane retardation and the angle of the in-plane slow axis of the second birefringent layer (eighth layer) are denoted by Δnd1 and −θ1, respectively.

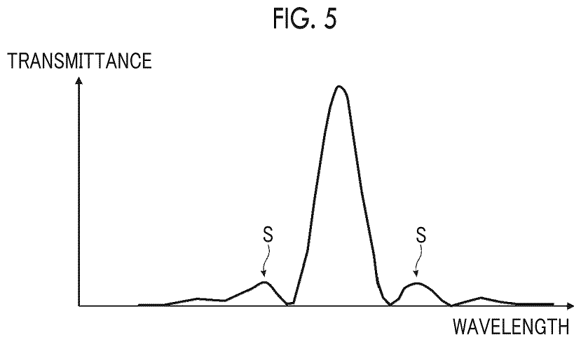

In the band-pass filter, as conceptually shown in FIG. 5, a transmission wavelength region, which is called a side lobe, is generated as shown by the arrow S in the drawing at a position of a shorter wavelength and a position of a longer wavelength than a target transmission wavelength range, with the target transmission wavelength range being sandwiched.

In contrast, the side lobe can be reduced by increasing the in-plane retardations and decreasing the angle of the in-plane slow axis in the birefringent layers of the birefringent layer sets on both sides in the thickness direction, as compared with the birefringent layers of the birefringent layer set in the center in the thickness direction, as described above.

Furthermore, the in-plane retardation of the birefringent layer may be adjusted, for example, by changing the thickness of the birefringent layer (in-plane periodic structure layer), but may also be adjusted by changing the material (refractive index) to be used.

In such a configuration in which the in-plane retardations are increased and the angles of the in-plane slow axes are decreased in the birefringent layers of the birefringent layer sets in both sides in the thickness direction, as compared with the birefringent layers of the birefringent layer set in the center in the thickness direction, there is no limit on the number of the birefringent layers in the center, with which the in-plane retardations are increased and the angles of the in-plane slow axes are decreased in the birefringent layers, as compared with the both sides. That is, there is no limit on how to divide the birefringent layer sets between the both sides and the center, and thus, the number or the division may be appropriately set depending on the number of the birefringent layers (birefringent layer sets) included in the filter.

In addition, with regard to the in-plane retardations and the angles of the in-plane slow axes of the birefringent layers of the birefringent layer sets on both sides in the thickness direction, and the in-plane retardations and the angles of the in-plane slow axes of the birefringent layers of the birefringent layer set in the center in the thickness direction, optimum in-plane retardations and angles of the in-plane slow axes, with which the polarization interference element acts as a λ/2 retardation plate and the side lobe can be reduced, may be set by simulation.

Furthermore, it is preferable that the change in angles of the in-plane slow axes of the birefringent layers of the birefringent layer sets from both sides to the center in the lamination direction (thickness direction), and the distribution of the in-plane retardations of the birefringent layers of the birefringent layer sets in the thickness direction are controlled as gently and finely as possible.

In addition, the polarization interference element of the embodiment of the present invention may also be configured to have a birefringent layer set including a birefringent layer consisting of only an in-plane periodic structure layer, and a birefringent layer set including a birefringent layer consisting of an in-plane periodic structure layer and a thickness-direction periodic structure layer.

In addition, in the example shown in FIG. 3, the first birefringent layer 20 and the second birefringent layer 24 are configured such that the thickness-direction periodic structure layer and the in-plane periodic structure layer are laminated in this order from the first polarizer 12 side. However, the present invention is not limited thereto, and the birefringent layer may also be configured such that the in-plane periodic structure layer and the thickness-direction periodic structure layer are laminated in this order from the first polarizer 12 side.

### In-Plane Periodic Structure Layer

The in-plane periodic structure layer has a periodic structure in which two types of unit layers having different refractive indices are alternately laminated adjacent to each other in an in-plane direction, which is not particularly limited as long as light in a target wavelength range can be transmitted.

The in-plane periodic structure layer ultimately serves as a birefringent layer, but a material thereof may not exhibit birefringence. Therefore, a structure birefringent layer exhibiting birefringence can also be used by adjusting the periodic structure thereof using a material exhibiting optical isotropy.

As an example of the in-plane periodic structure layer, a member having an uneven structure part having a period shorter than the design wavelength on a surface thereof may be mentioned. In this case, the convex part corresponds to a layer with a high refractive index, and the air layer of the concave part corresponds to a layer with a low refractive index. In addition, the concave part may be filled with a material having a refractive index lower than that of a material forming the convex part to form the layer with a low refractive index.

As the in-plane periodic structure layer having an uneven structure, various in-plane periodic structure layers described in JP2018-180112A, JP2007-101856A, and the like can be appropriately used.

In addition, examples of the in-plane periodic structure layer include an optical phase difference element having a substrate having an uneven structure part with a period shorter than a design wavelength on the surface, a first coating film that has a refractive index higher than a material of a convex part of the uneven structure part of the substrate and is formed on the convex part of the uneven structure part, and a second coating film formed to cover the first coating film and the concave part of the uneven structure part, in which an air layer is formed in the concave part, as described in JP2007-101856A. In the optical phase difference element, the first coating film and the convex part correspond to the layer with a high refractive index, and the air layer of the concave part and the third coating film correspond to the layer with a low refractive index.

The material of the layer with a high refractive index is not particularly limited, and resin materials of various polymers with a high refractive index, such as acrylic polymers (for example, those described in JP5463170B, JP2013-095833A, and the like), inorganic materials such as quartz glass (SiO₂), TiO₂, Ta₂O₅, HfO₂, Si₃N₄, Zn₂SnO₄, and Nb₂O₅, or the like can be used.

The material of the layer with a low refractive index is not particularly limited, but air, resin materials such as a polymer nanocomposite (for example, those described in JP6121204B), inorganic materials such as quartz glass (SiO₂), TiO₂, Ta₂O₅, HfO₂, Si₃N₄, Zn₂SnO₄, and Nb₂O₅, or the like can be used.

In the in-plane periodic structure layer, the difference between the refractive index of the layer with a high refractive index and the refractive index of the layer with a low refractive index may be appropriately set depending on a required in-plane retardation (Δnd) and the like. The difference in refractive index between the layer with a high refractive index and the layer with a low refractive index is preferably 0.1 or more, and more preferably 0.5 or more.

Such an in-plane periodic structure layer may be manufactured by a known method.

### Thickness-Direction Periodic Structure Layer

The thickness-direction periodic structure layer has a periodic structure in which two types of unit layers having different refractive indices are alternately laminated adjacent to each other in the thickness direction, and is not particularly limited as long as light in a target wavelength range can be transmitted.

The thickness-direction periodic structure layer is a known multilayer film in which a layer with a high refractive index and a layer with a low refractive index, each having a thickness sufficiently smaller than a design wavelength, are alternately laminated. Such a multilayer film is described in JP2004-102200A and the like.

As a material of the layer with a high refractive index and a material of the layer with a low refractive index, the same materials as the layer with a high refractive index and the layer with a low refractive index of the in-plane periodic structure layer can be used.

In the thickness-direction periodic structure layer, the difference between the refractive index of the layer with a high refractive index and the refractive index of the layer with a low refractive index may be appropriately set depending on a required in-plane retardation (Δnd) and the like. The difference in refractive index between the layer with a high refractive index and the layer with a low refractive index is preferably 0.1 or more, and more preferably 0.5 or more.

Such a thickness-direction periodic structure layer may be manufactured by a known method.

In addition, the first birefringent layer and the second birefringent layer can be formed by forming each of the in-plane periodic structure layer and the thickness-direction periodic structure layer, and then bonding the layers with an adhesive which is transparent to transmitted light, such as an optical clear adhesive (OCA) and an acrylic pressure sensitive adhesive.

Next, the manufactured first birefringent layer and second birefringent layer are bonded with OCA or the like such that the angle of the in-plane slow axis is a predetermined angle, thereby forming a birefringent layer set. A plurality of such birefringent layer sets are manufactured, and the birefringent layer sets are further laminated to prepare a polarization interference element. In a case of laminating the birefringent layer sets, the birefringent layer sets may be laminated by bonding with OCA or the like. In addition, during the lamination of the birefringent layer sets, the birefringent layer sets are laminated such that the bisectors of the angles formed between the in-plane slow axes of the first birefringent layers and the in-plane slow axes of the second birefringent layers in the respective birefringent layer sets are parallel to each other.

The polarization interference element manufactured as described above is arranged, for example, such that the transmission axis of the first polarizer, and the bisector of an angle formed between the in-plane slow axis of the first liquid crystal layer and the in-plane slow axis of the second birefringent layer of each birefringent layer set are parallel to each other, and further, the second polarizer is arranged in a crossed nicols state with the first polarizer, whereby a filter as shown in FIG. 1 can be manufactured.

Such a polarization interference element and filter of the embodiment of the present invention can be used at any wavelength. That is, the polarization interference element and the filter of the embodiments of the present invention can be used for any electromagnetic waves such as ultraviolet rays, visible light, infrared rays, terahertz waves, and millimeter waves.

In the filter of the embodiment of the present invention, the transmission axes of the polarizers arranged in a crossed nicols state are set to an appropriate angle in order to preferably obtain desired band-pass characteristics. In particular, it is possible to reduce the size of the side lobe generated on both sides of the main band-pass wavelength (the longer wave side and the shorter wave side) and to adjust the sizes of the side lobes on the longer wave side and the shorter wave side to be equal.

In the filter of the embodiment of the present invention, a retardation layer can be provided on one side or both sides of the polarizers arranged in a crossed nicols state. This retardation layer brings about an effect of maintaining the orthogonal relationship of the polarization direction by the linear polarizer arranged in a crossed nicols state not only in the front but also in an off-axis direction of the polarizer, that is, a direction tilted from the front in an oblique direction at an angle of 45 degrees at an orientation different from the orientation of the transmission axis and/or the absorption axis of the polarizer. This makes it possible to obtain good band-pass characteristics that are the same as those in the front even in the oblique direction. By making the in-plane slow axis of the retardation layer parallel to an absorption axis of any of the set of the polarizers arranged in a crossed nicols state, the polarization state can be compensated to maintain the orthogonal relationship of the polarization direction in the oblique direction without giving an influence on the front. As the retardation layer, a positive C-plate and a positive A-plate, a negative C-plate and a negative A-plate, or a combination thereof is used. Alternatively, a B-plate (with an Nz factor of 0.1 to 0.9) that is a biaxial refractive index body can also be used. As the material, various optical crystals, birefringent materials such as a periodic structure body due to structural birefringence, and a liquid crystal compound (a rod-like liquid crystal compound and/or a disk-like liquid crystal compound), a birefringent film using alignment by stretching of a film including a polymer, or the like can be preferably used.

In addition, the configuration of the filter using the liquid crystal polarization interference element of the embodiment of the present invention is not limited to a configuration in which the liquid crystal polarization interference element is arranged between the two polarizers arranged in a crossed nicols state. For example, the filter of the embodiment of the present invention may be configured such that the liquid crystal polarization interference element of the embodiment of the present invention is arranged between two polarizers arranged in a parallel nicols state. That is, the filter of the embodiment of the present invention may be configured such that the liquid crystal polarization interference element is arranged between two polarizers that are arranged such that transmission axes thereof are parallel to each other. In this case, it is preferable that the liquid crystal polarization interference element is configured such that liquid crystal layers having the same thickness and having angles formed between the direction of the transmission axis of the polarizer and the slow axis of ρ, 3ρ, 5ρ, . . . are laminated. The liquid crystal polarization interference element having such a configuration is also referred to as a Solc filter (or fan Solc filter).

Hereinabove, the polarization interference element and the filter of the embodiments of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail with reference to Examples. The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited to specific examples shown below.

### Example 1

### Manufacture of In-Plane Periodic Structure Layer

An in-plane retardation plate (in-plane periodic structure layer Δnd=275 nm) having the structure shown in FIG. 1 of JP2007-101856A was manufactured with reference to the method described in Example 1 of JP2007-101856A.

Specifically, a quartz glass substrate having a refractive index of 1.45 and a thickness of 0.1 mm was prepared as a substrate. Next, an uneven structure part having a period of 320 nm, a width (line width) of a convex part of 150 nm, and a groove depth of 540 nm was manufactured on an upper surface of the quartz glass substrate.

Next, a quartz glass substrate having an uneven structure part was mounted in a sputtering device, and a film made of Ta₂O₅ having a refractive index n2 of 2.2 was formed as the first coating film and the third coating film, respectively, to a thickness of 270 nm on the convex part and the concave part of the uneven structure part.

Next, an acrylic film having a refractive index n3 of 1.5 was formed, as the second coating film, on the first coating film of the quartz glass substrate, on which the first coating film and the third coating film had been formed on the uneven structure part. The film thickness of the second coating film was about 300 nm. An in-plane retardation plate (Δnd=275 nm) was manufactured.

Eight such in-plane periodic structure layers were manufactured.

The one in-plane periodic structure layer manufactured as described above was used as a birefringent layer, and two birefringent layers (in-plane periodic structure layers) were bonded using a pressure sensitive adhesive (SK Dyne 2057, manufactured by Soken Chemical & Engineering Co., Ltd.) such that the angle formed between the in-plane slow axes was 11.25°, that is, the angles with respect to the bisector of the angle formed between the in-plane slow axes were +5.625° and −5.625°, respectively, to manufacture a birefringent layer set. In the same manner, four birefringent layer sets were formed.

Four birefringent layer sets were bonded using a pressure sensitive adhesive (SK Dyne 2057, manufactured by Soken Chemical & Engineering Co., Ltd.) to manufacture a polarization interference element. In this case, the liquid crystal layers were laminated such that the bisector of the angle formed between the in-plane slow axes in each of the liquid crystal layer sets was parallel to the bisector of the angle formed between the in-plane slow axes in the birefringent layer sets.

A filter was manufactured by laminating two polarizers arranged in a crossed nicols state to sandwich the manufactured polarization interference element. In this case, the liquid crystal layers were laminated such that the transmission axis of one polarizer and the bisector of an angle formed between the in-plane slow axes in each birefringent layer set were parallel to each other.

### Evaluation

For the manufactured filter, the peak wavelength and the half-width of transmitted light, as well as the wavelength shift value and the side lobe value were measured using a spectroradiometer “SR-3” manufactured by Topcon Technohouse Corporation. First, a peak wavelength (central wavelength) and a half-width of transmitted light in a case where light was incident from a polar angle of 0° (direction perpendicular to the filter) were measured. Next, in the measurement of the wavelength shift, the reference of the azimuthal angle was set to an angle that bisects the intersection angle between the in-plane slow axis of the first birefringent layer and the in-plane slow axis of the second birefringent layer, and an average value of the wavelength shift values in a case where light was incident from a polar angle of 60° in the directions of the azimuthal angles of 0° and 90° was determined. In addition, the side lobe value was determined as an average value of proportions of the transmittance at the wavelength of the side lobe on both sides to the transmittance at the peak wavelength.

The results are shown in Table 1 below.

TABLE 1

| Vertical incidence | | Oblique incidence | |
|---|---|---|---|
| Central wavelength | Half-width | Wavelength shift | Side lobe |
| nm | nm | value nm | value |
| 550 | 120 | 80 | 10% |

### Example 2

Eight in-plane periodic structure layers were manufactured in the same manner as in Example 1.

### Manufacture of Thickness-Direction Periodic Structure Layer

A thickness-direction retardation plate (thickness-direction periodic structure layer) was manufactured with reference to the method described in JP2007-108436A.

Specifically, a quartz glass substrate having a refractive index of 1.45 and a thickness of 0.1 mm was prepared as a substrate, and SiO₂ and TiO₂ were alternately vapor-deposited on the other surface of the substrate using a sputtering device under reduced pressure to manufacture a thickness-direction periodic structure layer consisting of a total of 108 layers, each of which had 54 layers. The manufactured thickness-direction periodic structure layer had a total thickness of 1,578 nm and a thickness-direction phase difference Rth of 138 nm.

Eight such thickness-direction periodic structure layers were manufactured.

### Manufacture of Birefringent Layer

One in-plane periodic structure layer and one thickness-direction periodic structure layer were bonded to each other using a pressure sensitive adhesive (SK-Dyne 2057, manufactured by Soken Chemical & Engineering Co., Ltd.) to manufacture a birefringent layer.

Eight such birefringent layers were manufactured.

The two birefringent layers were bonded using a pressure sensitive adhesive (SK Dyne 2057, manufactured by Soken Chemical & Engineering Co., Ltd.) such that the angle formed between the in-plane slow axes of the two birefringent layers (in-plane slow axes of the in-plane periodic structure layers) was 11.25°, that is, the angles with respect to the bisector of the angle formed between the in-plane slow axes were +5.625° and −5.625°, respectively, to manufacture a birefringent layer set. In the same manner, four birefringent layer sets were manufactured.

Four birefringent layer sets were bonded using a pressure sensitive adhesive (SK Dyne 2057, manufactured by Soken Chemical & Engineering Co., Ltd.) to manufacture a polarization interference element. In this case, the liquid crystal layers were laminated such that the bisector of the angle formed between the in-plane slow axes in each of the liquid crystal layer sets was parallel to the bisector of the angle formed between the in-plane slow axes in the birefringent layer sets.

A filter was manufactured by laminating two polarizers arranged in a crossed nicols state to sandwich the manufactured polarization interference element. In this case, the liquid crystal layers were laminated such that the transmission axis of one polarizer and the bisector of an angle formed between the in-plane slow axes in each birefringent layer set were parallel to each other.

### Evaluation

For the manufactured filter, the peak wavelength and the half-width of transmitted light, as well as the wavelength shift value and the side lobe value were measured using a spectroradiometer “SR-3” manufactured by Topcon Technohouse Corporation in the same manner as described above.

The results are shown in Table 2 below.

TABLE 2

| Vertical incidence | | Oblique incidence | |
|---|---|---|---|
| Central wavelength | Half-width | Wavelength shift | Side lobe |
| nm | nm | value nm | value |
| 550 | 120 | Less than 5 | 10% |

### Example 3

A polarization interference element was manufactured in the same manner as in Example 2, except that the number of SiO₂ layers and the number of TiO₂ layers in the thickness-direction periodic structure layer were changed to 27 each for a total of 54 layers in Example 2, and a filter was thus manufactured.

The manufactured thickness-direction periodic structure layer had a total thickness of 789 nm and a thickness-direction phase difference Rth of 69 nm.

### Evaluation

For the manufactured filter, the peak wavelength and the half-width of transmitted light, as well as the wavelength shift value and the side lobe value were measured using a spectroradiometer “SR-3” manufactured by Topcon Technohouse Corporation in the same manner as described above.

The results are shown in Table 3 below.

TABLE 3

| Vertical incidence | | Oblique incidence | |
|---|---|---|---|
| Central wavelength | Half-width | Wavelength shift | Side lobe |
| nm | nm | value nm | value |
| 550 | 120 | 30 | 10% |

### Example 4

An in-plane periodic structure layer was manufactured using the same method as in Example 1, except that the in-plane retardation Δnd was set to 291 nm or 267 nm by adjusting the groove depth of the in-plane periodic structure layer and the thickness of the coating film.

In addition, a thickness-direction periodic structure layer was manufactured in the same manner as in Example 2, and a birefringent layer was manufactured by bonding the thickness-direction periodic structure layer to the in-plane periodic structure layer with a pressure sensitive adhesive.

The manufactured birefringent layer was laminated with a pressure sensitive adhesive to have the configuration shown in Table 4 below to manufacture a polarization interference element, and a filter was thus manufactured.

TABLE 4

| | | In-plane | Thickness-direction | |
|---|---|---|---|---|
| | | periodic | periodic structure | Angle of |
| | | structure | layer | in-plane |
| Birefringent | Birefringent | layer Re | Rth | slow axis |
| layer set | layer | nm | nm | ° |
| First | First | 291 | 145 | 1.8 |
| | Second | 291 | 145 | −1.8 |
| Second | First | 267 | 134 | 9.4 |
| | Second | 267 | 134 | −9.4 |
| Third | First | 267 | 134 | 9.4 |
| | Second | 267 | 134 | −9.4 |
| Fourth | First | 291 | 145 | 1.8 |
| | Second | 291 | 145 | −1.8 |

### Evaluation

For the manufactured filter, the peak wavelength and the half-width of transmitted light, as well as the wavelength shift value and the side lobe value were measured using a spectroradiometer “SR-3” manufactured by Topcon Technohouse Corporation in the same manner as described above.

The results are shown in Table 5 below.

TABLE 5

| Vertical incidence | | Oblique incidence | |
|---|---|---|---|
| Central wavelength | Half-width | Wavelength shift | Side lobe |
| nm | nm | value nm | value |
| 550 | 120 | Less than 5 | 3% or less |

### Example 5

While Examples 1 to 4 used the filters that transmitted visible light at a wavelength of 550 nm, a filter that transmits ultraviolet rays at a wavelength of 222 nm was manufactured.

An in-plane periodic structure layer was manufactured using the same method as in Example 1, except that the in-plane retardation Δnd was set to 117 nm or 108 nm by adjusting the groove depth of the in-plane periodic structure layer and the thickness of the coating film.

A thickness-direction periodic structure layer was manufactured in the same manner as in Example 2, except that the thickness-direction retardation was set to 59 nm or 54 nm by changing the number of layers.

A birefringent layer was manufactured by bonding an in-plane periodic structure layer having an in-plane retardation of 117 nm to a thickness-direction periodic structure layer having a thickness-direction retardation of 59 nm with a pressure sensitive adhesive. In addition, a birefringent layer was manufactured by bonding an in-plane periodic structure layer having an in-plane retardation of 108 nm to a thickness-direction periodic structure layer having a thickness-direction retardation of 54 nm with a pressure sensitive adhesive.

The manufactured birefringent layer was laminated with a pressure sensitive adhesive to have the configuration shown in Table 6 below to manufacture a polarization interference element, and a filter was thus manufactured.

TABLE 6

| | | In-plane | Thickness-direction | |
|---|---|---|---|---|
| | | periodic | periodic structure | Angle of |
| | | structure | layer | in-plane |
| Birefringent | Birefringent | layer Re | Rth | slow axis |
| layer set | layer | nm | nm | ° |
| First | First | 117 | 59 | 1.8 |
| | Second | 117 | 59 | −1.8 |
| Second | First | 108 | 54 | 9.4 |
| | Second | 108 | 54 | −9.4 |
| Third | First | 108 | 54 | 9.4 |
| | Second | 108 | 54 | −9.4 |
| Fourth | First | 117 | 59 | 1.8 |
| | Second | 117 | 59 | −1.8 |

### Evaluation

For the manufactured filter, the peak wavelength and the half-width of transmitted light, as well as the wavelength shift value and the side lobe value were measured using a spectroradiometer “SR-3” manufactured by Topcon Technohouse Corporation in the same manner as described above.

The results are shown in Table 7 below.

TABLE 7

| Vertical incidence | | Oblique incidence | |
|---|---|---|---|
| Central wavelength | Half-width | Wavelength shift | Side lobe |
| nm | nm | value nm | value |
| 222 | 120 | Less than 5 | 3% or less |

From Examples 1 to 5, it can be seen that the polarization interference element of the embodiment of the present invention has a novel configuration and can be used for a band-pass filter and the like. In addition, it can be seen that the effect is exhibited not only on visible light but also on ultraviolet rays.

Moreover, from the comparison between Example 1 and Examples 2 and 3, it can be seen that the wavelength shift value could be reduced by providing the thickness-direction periodic structure layer in the birefringent layer. Furthermore, from the comparison between Example 2 and Example 3, it can be seen that the sum of the in-plane retardations of the in-plane periodic structure layers is preferably about 2 times the sum of the thickness-direction retardations of the thickness-direction periodic structure layers.

In addition, from the comparison between Example 2 and Example 4, it can be seen that the side lobe of the band-pass filter can be reduced by decreasing the in-plane retardation values of the birefringent layers of the birefringent layer sets on both sides in the thickness direction and increasing the absolute value of the slow axis θ of the birefringent layer, as compared with the birefringent layer of the birefringent layer set in the center in the thickness direction.

### Example 6

In Example 2, eight birefringent layers (the first birefringent layers and the second birefringent layers) were manufactured to form four birefringent layer sets, whereas twelve birefringent layers (the first birefringent layers and the second birefringent layers) were manufactured to form six birefringent layer sets. The two birefringent layers were bonded using a pressure sensitive adhesive (SK Dyne 2057, manufactured by Soken Chemical & Engineering Co., Ltd.) such that the angle formed between the in-plane slow axes of the two birefringent layers (in-plane slow axes of the in-plane periodic structure layers) was 7.5°, that is, the angles with respect to the bisector of the angle formed between the in-plane slow axes were +3.75° and −3.75°, respectively, to manufacture a birefringent layer set. A filter was manufactured in the same manner as in Example 2, except for the above, and the wavelength shift value and the side lobe value were measured. The results are shown in Table 8 below.

TABLE 8

| Vertical incidence | | Oblique incidence | |
|---|---|---|---|
| Central wavelength | Half-width | Wavelength shift | Side lobe |
| nm | nm | value nm | value |
| 550 | 80 | Less than 5 | 10% |

From the results of Example 6, it can be seen that even in a case where the total number of birefringent layers is different, a novel configuration can be used for a band-pass filter and the like.

### Example 7

In Example 1, a retardation layer was arranged between one polarizer of the polarizers arranged in a crossed nicols state and the polarization interference element. The retardation layer brings about an effect of maintaining the orthogonal relationship of the polarization directions by the linear polarizers arranged in a crossed nicols state not only in the front but also in an oblique direction. A negative C plate (thickness-direction retardation Rth: 90 nm) and a negative A plate (in-plane-direction retardation Re: 140 nm) were arranged and bonded in this order adjacent to the first polarizer. In this case, the in-plane fast axis of the negative A-plate was installed in parallel with the absorption axis of the polarizer on one side. In this manner, a filter was manufactured, and the wavelength shift value and the side lobe value were measured in the same manner as in Example 1. The results are shown in Table 9 below.

TABLE 9

| Vertical incidence | | Oblique incidence | |
|---|---|---|---|
| Central wavelength | Half-width | Wavelength shift | Side lobe |
| nm | nm | value nm | value |
| 550 | 120 | Less than 3 | 10% |

From the results of Example 7, it can be seen that the wavelength shift value was smaller than that in Example 1 by arranging the retardation layer between the polarizer and the polarization interference element.

### Example 8

In Example 2, a polarization interference element was manufactured by arranging eight birefringent layers such that the angles of the in-plane slow axes had the relationship shown in Table 10 below, and a filter was manufactured by changing the arrangement of the polarizer from a crossed nicols state to a parallel nicols state. The arrangement of the birefringent layers in Example 8 corresponds to a band-pass filter in which a Solc filter (Fan Solc filter) is arranged between polarizers arranged in a parallel nicols state, the Solc filter being formed by laminating birefringent plates (λ/2 retardation plates) having the same thickness and having angles formed between the direction of the transmission axis of the polarizer and the slow axis of ρ, 3ρ, 5ρ, . . .

TABLE 10

| Birefringent | Birefringent | Angle of in-plane |
|---|---|---|
| layer set | layer | slow axis ° |
| First | First | 5.625 |
| | Second | 16.875 |
| Second | First | 28.125 |
| | Second | 39.375 |
| Third | First | 50.625 |
| | Second | 61.875 |
| Fourth | First | 73.125 |
| | Second | 84.375 |

For the manufactured filter, the wavelength shift value and the side lobe value were measured in the same manner as in Example 2. The results are shown in Table 11 below.

TABLE 11

| Vertical incidence | | Oblique incidence | |
|---|---|---|---|
| Central wavelength | Half-width | Wavelength shift | Side lobe |
| nm | nm | value nm | value |
| 550 | 120 | Less than 5 | 10% |

From the results of Example 8, it can be seen that even in a configuration in which each of the birefringent layers was arranged such that the angles formed between the direction of the transmission axis of the polarizer and the angle of the slow axis were ρ, 3ρ, 5ρ, . . . , a novel configuration can be used in a band-pass filter and the like.

From the results above, the effects of the present invention are apparent.

The optical filter of the embodiment of the present invention can be suitably used as a band-pass filter and the like in various optical devices.

### EXPLANATION OF REFERENCES

10: filter
12: first polarizer
14: second polarizer
16: polarization interference element
20, 20a, 20n: first birefringent layer
21: first in-plane periodic structure layer
21H, 22H, 25H: layer with a high refractive index
21L, 22L, 25L: layer with a low refractive index
22: thickness-direction periodic structure layer
24, 24a, 24n: second birefringent layer
25: second in-plane periodic structure layer
26, 26a, 26n: birefringent layer set

What is claimed is:

1. A polarization interference element comprising:
two or more birefringent layer sets in a thickness direction, each set consisting of two birefringent layers,
wherein the birefringent layer includes an in-plane periodic structure layer having a periodic structure in which two types of unit layers having different refractive indices are alternately laminated adjacent to each other in an in-plane direction,
slow axes of the birefringent layers constituting the birefringent layer set intersect with each other, and
in-plane retardations of the two birefringent layers constituting the birefringent layer set are equal to each other.

2. The polarization interference element according to claim 1,
wherein the birefringent layer further includes a thickness-direction periodic structure layer consisting of a periodic structure in which two types of unit layers having different refractive indices are alternately laminated adjacent to each other in the thickness direction.

3. The polarization interference element according to claim 2,
wherein in the one birefringent layer, a sum of in-plane retardations of the in-plane periodic structure layer is 1.33 times to 4 times a sum of thickness-direction retardations of the thickness-direction periodic structure layer.

4. The polarization interference element according to claim 1,
wherein the polarization interference element has three or more birefringent layer sets in the thickness direction, and
an angle formed between in-plane slow axes of the two birefringent layers and in-plane retardations in the birefringent layers differ between birefringent layer sets arranged on both sides in the thickness direction and birefringent layer set arranged in a central part in the thickness direction.

5. A filter comprising:
the polarization interference element according to claim 1; and
two polarizers that sandwich the polarization interference element in a thickness direction,
wherein the two polarizers are arranged such that transmission axes of the two polarizers are orthogonal to each other.

6. The filter according to claim 5,
wherein a retardation layer is included between one or both of the two polarizers and the birefringent layer set, and
an in-plane slow axis of the retardation layer is parallel to an absorption axis of either of the two polarizers.

7. The polarization interference element according to claim 2,
wherein the polarization interference element has three or more birefringent layer sets in the thickness direction, and
an angle formed between in-plane slow axes of the two birefringent layers and in-plane retardations in the birefringent layers differ between birefringent layer sets arranged on both sides in the thickness direction and birefringent layer set arranged in a central part in the thickness direction.

8. The polarization interference element according to claim 3,
wherein the polarization interference element has three or more birefringent layer sets in the thickness direction, and
an angle formed between in-plane slow axes of the two birefringent layers and in-plane retardations in the birefringent layers differ between birefringent layer sets arranged on both sides in the thickness direction and birefringent layer set arranged in a central part in the thickness direction.

9. A filter comprising:
the polarization interference element according to claim 2; and
two polarizers that sandwich the polarization interference element in a thickness direction,
wherein the two polarizers are arranged such that transmission axes of the two polarizers are orthogonal to each other.

10. The filter according to claim 9,
wherein a retardation layer is included between one or both of the two polarizers and the birefringent layer set, and
an in-plane slow axis of the retardation layer is parallel to an absorption axis of either of the two polarizers.

11. A filter comprising:
the polarization interference element according to claim 3; and
two polarizers that sandwich the polarization interference element in a thickness direction,
wherein the two polarizers are arranged such that transmission axes of the two polarizers are orthogonal to each other.

12. The filter according to claim 11,
wherein a retardation layer is included between one or both of the two polarizers and the birefringent layer set, and
an in-plane slow axis of the retardation layer is parallel to an absorption axis of either of the two polarizers.

13. A filter comprising:
the polarization interference element according to claim 4; and
two polarizers that sandwich the polarization interference element in a thickness direction,
wherein the two polarizers are arranged such that transmission axes of the two polarizers are orthogonal to each other.

14. The filter according to claim 13,
wherein a retardation layer is included between one or both of the two polarizers and the birefringent layer set, and
an in-plane slow axis of the retardation layer is parallel to an absorption axis of either of the two polarizers.

15. A filter comprising:
the polarization interference element according to claim 7; and
two polarizers that sandwich the polarization interference element in a thickness direction,
wherein the two polarizers are arranged such that transmission axes of the two polarizers are orthogonal to each other.

16. The filter according to claim 15,
wherein a retardation layer is included between one or both of the two polarizers and the birefringent layer set, and
an in-plane slow axis of the retardation layer is parallel to an absorption axis of either of the two polarizers.

17. A filter comprising:
the polarization interference element according to claim 8; and
two polarizers that sandwich the polarization interference element in a thickness direction,
wherein the two polarizers are arranged such that transmission axes of the two polarizers are orthogonal to each other.

18. The filter according to claim 17,
wherein a retardation layer is included between one or both of the two polarizers and the birefringent layer set, and
an in-plane slow axis of the retardation layer is parallel to an absorption axis of either of the two polarizers.
